(19) United States
(12) Patent Application Publication
(10) Pub. No.: US 2002/0022948 A1
(43) Pub. Date: Feb. 21, 2002

(54) Method of adjusting characteristics of electronic part

(75) Inventors: Takahiro Okada, Nomi-gun (JP); Jinsei Ishihara, Kanazawa-shi (JP); Hideyuki Kato, Ishikawa-gun (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/903,480

(22) Filed: Jul. 11, 2001

(30) Foreign Application Priority Data
Jul. 19, 2000 (JP) 2000-219075

(51) Int. Cl. G06F 17/50

(52) U.S. Cl. 703/13

(57) ABSTRACT

A method of adjusting characteristics of an electronic part such as a dielectric filter. Values of predetermined characteristics of the electronic part are measured. An electromagnetic field simulation is performed to determine characteristic values of the electronic part which would be obtained when a plurality of structural parameters, corresponding to dimensions of selected portions of the electronic part are varied. Amounts of variations of the parameter values from the design parameter values which have to be made to make the difference between the measured characteristic values and the design characteristic values fall within a predetermined range of allowable error are determined based on the results of the simulation. The selected portions of the electronic part corresponding to the structural parameters are adjusted by the amounts of variations.

### BACKGROUND OF THE INVENTION

1. Field of the Invention

The present invention relates to a method of adjusting the characteristics of an electronic part whose characteristics are susceptible to variation through adjustment of parameters such as a dimensions of a specific adjustable portion or factors of the electronic part.

2. Description of the Related Art

Hitherto, adjustment of characteristics of an electronic part, typically a filter comprising a dielectric block and electrode films formed thereon, has relied upon manual work of workers. More specifically, workers are instructed and trained by a person who has acquired know-how of the adjusting work through a trial-and-error process. Consequently, an impractically long time is required for the manufacturer to commence a full-scale adjusting operation, or the yield is significantly reduced. In order to deal with this problem, proposals have been made in, for example, Japanese Unexamined Patent Application Publication Nos. 4-236505, 9-326615 and 10-171773.

More specifically, Japanese Unexamined Patent Application Publication No. 4-236505 discloses a method in which the portion or the factor to be adjusted is determined based on a prediction which is derived from a knowledge database in the light of the reflection characteristics of the filter. Japanese Unexamined Patent Application Publication No. 9-326615 proposes a technique which determines the portion or the factor to be adjusted by a fuzzy prediction conducted based on the filter characteristics. Japanese Unexamined Patent Application Publication No 10-171773 shows a method in which the portion or factor to be adjusted is specified by means of a circuit simulator, and a neutral network is used to diminish any mis-adjustment

These known methods, however, tend to cause mis-adjustment or may cause a reduction in the yield for the following reasons:

(1) It takes a long time to form a knowledge database and to establish a prediction rule. In addition, the knowledge database and prediction rule prepared for one type of electronic part are generally difficult to apply to other types of electronic parts.

(2) Learning a fuzzy predictive technique and neural network is also time-consuming.

(3) A filter having a structure in which a resonator and other elements interfere with one another cannot be perfectly expressed by an equivalent circuit. An equivalent circuit, even if it is obtainable, is highly intricate and may cause mis-adjustment when the adjustment is conducted by varying the values of circuit constant input to a circuit simulator. In addition, a wide variety of combinations of the circuit constants are conceivable, requiring a large number of steps until a conclusion is reached before the actual adjusting work is commenced.

### SUMMARY OF THE INVENTION

Accordingly, it is an object of the present invention to provide a method which enables adjustment of characteristics of an electronic part to be easily executed without fail.

To this end, according to the present invention, there is provided a method of adjusting characteristics of an electronic part, comprising: a measuring step for measuring at least the characteristic of the electronic part for performing an electromagnetic field simulation to determine the value of the characteristic which is to be obtained when the value of at least one structural parameter of said electronic part is varied from the design value, the structural parameters being, in accordance with one aspect of the invention, dimensions of a plurality of portions of the electronic part; and adjusting said structural parameter, based on the preceding step, which may be effected in accordance with another aspect of the invention by determining the amount of variation of the value of the structural parameter from the design value, which has to be effected to make the measured value of the characteristic fall within a predetermined range of allowable error from the design characteristic value; and adjusting the value of the structural parameter by an amount corresponding to the amount of variation.

Thus, the values of a predetermined item of the characteristics of the electronic part are determined through an electromagnetic field simulation upon entry of variable structural parameter values. The amount of adjustment necessary for making the measured characteristic value approximate the design characteristic value of the electronic part is determined based on the correlation between the value of the structural parameter and the characteristic value obtained trough the electromagnetic field simulation.

In one form of the present invention, correlations are determined based on the results of the electromagnetic field simulation, between the amount of variation of the value of the structural parameter and the amount of deviation of the value of the item of the characteristics from the design value. The correlations thus determined are stored in the form of table data. The variation amount determining step for determining the amount of variation of the value of the structural parameter, corresponding to the amount of deviation of the measured value of the item of the characteristics from the design characteristic value, is derived from item table data.

Thus, the correlation between the variation of the structural parameter and the amount of deviation of the actual characteristic value from the design characteristic value is stored beforehand in the form of table data. With this feature, it is possible to quickly determine the amount of variation of the structural parameter to be negated, i.e., the amount of adjustment to be performed, to achieve the desired characteristics.

Preferably, the measuring step, the simulating step, the variation amount determining step, and the adjusting step are cyclically repeated. The amount of adjustment to be effected in each cycle is set to a value smaller than the above-mentioned amount of variation, thereby bringing the actual value of item of the characteristics closer to the design characteristic value. With these features, even when deviations from the design values have been caused in many portions of the electronic device, the characteristics are made to progressively approach the design characteristics. In addition, the risk of mis-adjustment due to excessive correction can be diminished.

The above and other objects, features and advantages of the present invention will become clear from the following description of the preferred embodiment when the same is read in conjunction with the accompanying drawings.

### BRIEF DESCRIPTION OF THE DRAWINGS

Other features and advantages of the present invention will become apparent from the following description of the invention which refers to the accompanying drawings.

FIG. 1 is a perspective view of a dielectric filter to be adjusted in accordance with a method embodying the present invention.

FIG. 2 is a diagram showing the characteristics of the dielectric filter.

FIG. 3 is a block diagram of an apparatus which is used for adjusting, in accordance with the method embodying the present invention, characteristics of the dielectric filter.

FIG. 4 is a flowchart illustrative of a part of a process implementing an embodiment of the characteristic adjusting method in accordance with the present invention.

FIG. 5 is a flowchart showing a routine of a Step S2 shown in the flowchart of FIG. 4.

FIG. 6 is a flowchart illustrative of another part of a process implementing an embodiment of the characteristic adjusting method in accordance with the present invention.

FIG. 7 is a flowchart showing a process for forming table data used in the method of the present invention.

FIG. 8 is an illustration of an example of the table data.

### DETAILED DESCRIPTION OF EMBODIMENTS OF THE INVENTION

A first embodiment of the method in accordance with the present invention for adjusting characteristics of a dielectric filter will be described with reference to FIGS. 1 to 4.

Referring first to FIG. 1 which is a perspective view of a dielectric filter, a substantially rectangular parallelepiped dielectric block 1 has inner conductor holes 2a, 2b and 2c which are lined with inner conductors. The dielectric block 1 has an outer conductor 4 formed on five faces thereof except for an open end surface which is the surface facing leftward and downward as viewed in the figure. Input and output electrodes 5a and 5c, separate from the outer conductor 4, are provided so as to be exposed to the exterior. The above-mentioned open end surface of the dielectric block 1 has open-surface electrodes 3a and 3c which extend towards the central inner conductor hole 2b from the inner conductors lining the inner conductor holes 2a and 2c. Electrostatic capacitances are formed between these open-surface electrodes 3a, 3c and the opposing open end portions of the inner conductor which lines the inner conductor hole 2b. Electrostatic capacitances are also formed between the input and output electrodes 5a and 5c and portions of the inner conductor holes 2a and 2c, respectively. These electrostatic capacitances serve as coupling capacitances for coupling the input and output sides of the filter.

The structure shown in FIG. 1 provides three quarter-wavelength resonators each of which is opened at its one end and closed at the other end. Thus, a three-staged dielectric filter is formed in which two-adjacent resonators are coupled at their open ends through electrostatic capacitances.

The characteristics of the dielectric filter depend on factors including the dielectric constant of the dielectric block 1, dimensions of the dielectric block 1, and the dimensions of the conductors and electrodes formed in and on the dielectric block 1. Thus, in order to obtain a dielectric filter having desired filtering characteristics, factors are suitably selected and determined such as the material and dimensions of the dielectric block 1 and the dimensions of the open-surface electrodes 3a and 3c or those of the input and output electrodes 5a and 5c. Actually, however, these factors inevitably vary from product to product, so that an adjustment is essentially required to finally achieve the desired characteristics. For the purpose of simplification of description, an assumption is made here that the characteristics are adjusted solely through adjustment of the dimensions a1 and a2 over which the open-surface electrodes 3a and 3c extend towards the inner electrode hole 2b.

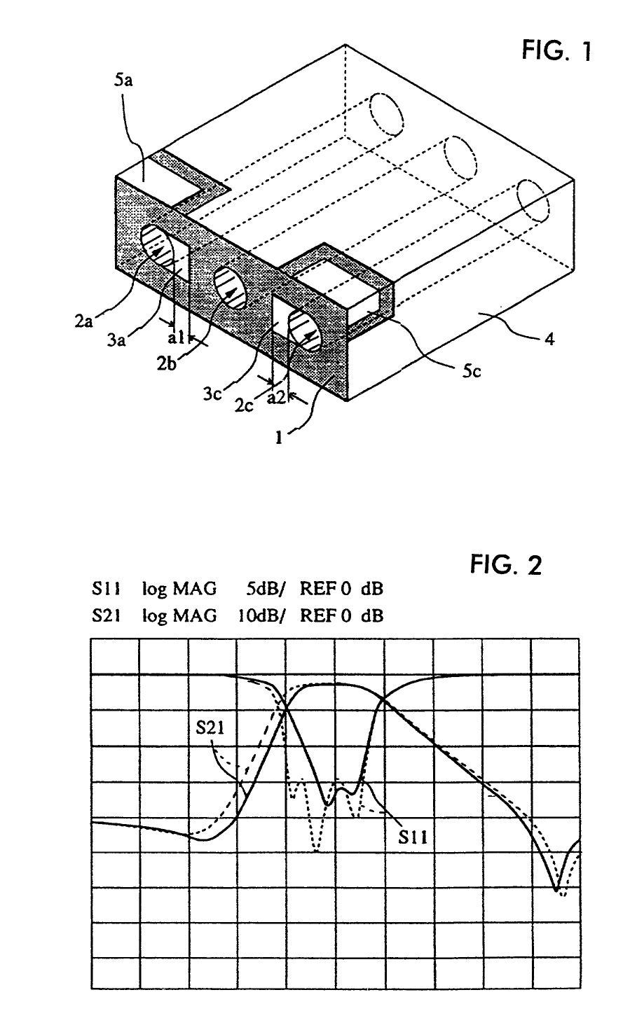

Referring now to FIG. 2, transmitting characteristic and reflecting characteristic of the dielectric filter are respectively shown by curves S21 and S11. Broken-line curves show design characteristics which are the target characteristics to be obtained through the adjustment, while solid-line curves show, by way of example, characteristics exhibited by the dielectric filter before the adjustment.

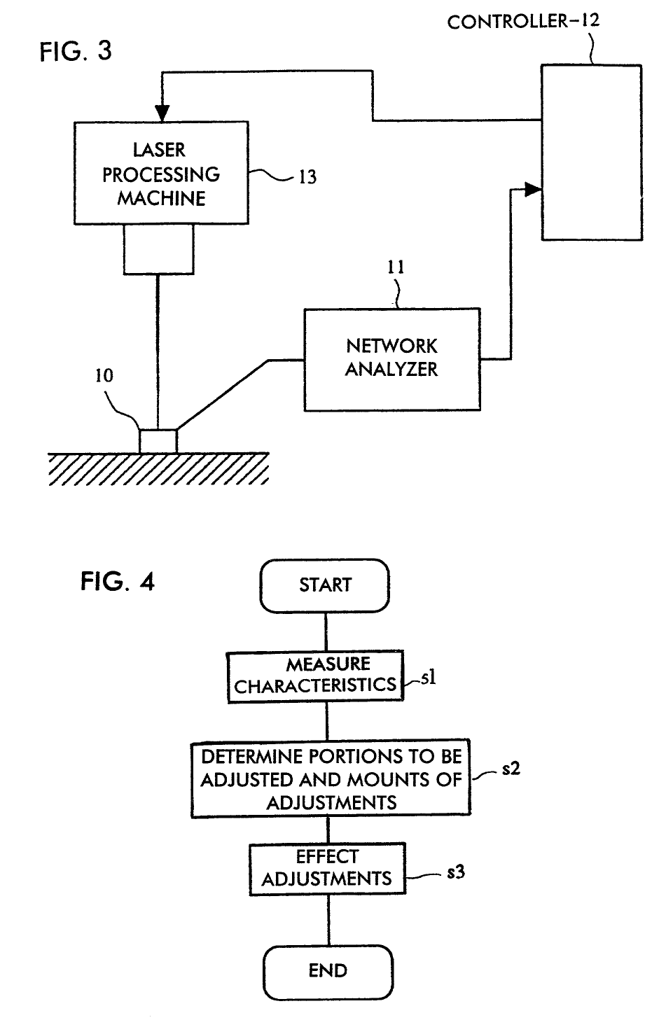

FIG. 3 is a block diagram showing the structure of an apparatus for adjusting the characteristics of the filter. A network analyzer 11 measures the transmitting characteristic and reflecting characteristic of the dielectric filter 10 to be adjusted. A controller 12 controls a laser processing machine 13 in accordance with a procedure which will be described later, so as to achieve the desired filter characteristics. The laser processing machine 13 trims the open-surface electrodes 3a and 3b of the dielectric filter 10, so as to vary the dimensions a1 and a2 shown in FIG. 1.

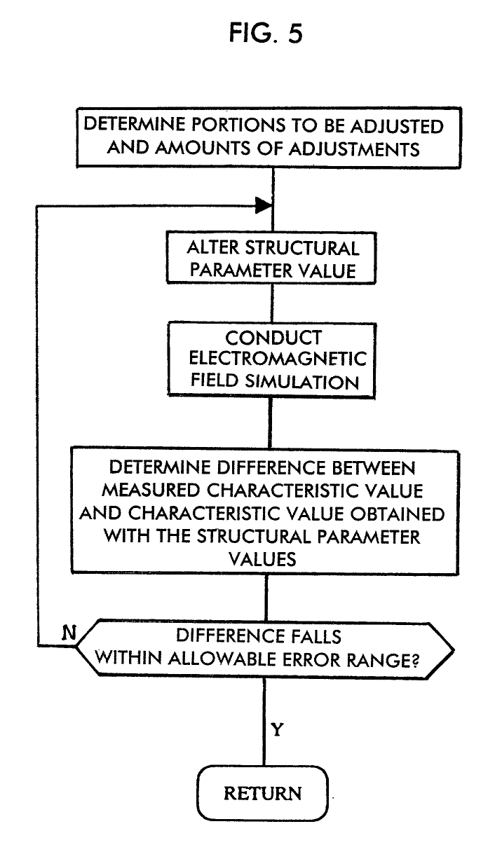

FIGS. 4 and 5 are flowcharts showing the process which is executed under the control of the controller 12 shown in FIG. 3. The process begins with a step S1 in which the network analyzer 11 measures the transmitting characteristic and the reflecting characteristics of the dielectric filter 10 over a predetermined frequency range, whereby characteristic data are obtained as shown by way of example in FIG. 2.

The process then proceeds to Step S2 which determines the portion to be adjusted in order to realize the characteristics shown by the broken-line curves in FIG. 2, as well as the amount of adjustment to be effected. Step S3 performs the adjustment of the determined portion by the determined amount. In the embodiment shown in FIG. 1, either one or both of the dimensions a1 and a2 of the open-surface electrodes 3a and 3c are trimmed by the determined amount or amounts.

FIG. 5 is a flowchart showing a routine executed in the Step S2 of the flow chart shown in FIG. 4. This routine begins with Step S21 which alters the value of the structural parameter to be trimmed, i.e., the dimension a1 and/or a2, among various structural parameters of the dielectric filter. For instance, in Step S22, the filter characteristic which would be obtained when the dimension a1 is reduced by a predetermined amount is analyzed by a three-dimensional electromagnetic field simulation. The analysis is performed by using an analytic technique which enables calculation of the characteristic when the structure and shape are given, such as a finite element method (FEM) or a finite difference time dividing method (FDTD).

Subsequently, Step S23 is executed which determines the difference between the characteristics simulated by using the altered structural parameter values and the actually measured characteristics. More specifically, difference between the characteristic obtained by using the structural parameter values and the measured characteristic is performed for each of the characteristic items such as the center frequency of the pass band, reflection loss at the center frequency, insertion loss at the center frequency, and insertion loss at a predetermined frequency which is on the high-or low-frequency end of the pass band. The above-described steps for altering the structural parameter values, analysis through electromagnetic field simulation, and determination of the difference between the characteristics obtained with the altered structural parameter values and the measured characteristics are repeated until the differences of all the items of the characteristics mentioned above come to fall within predetermined ranges of allowable errors.

The Step S21 of the above-described routine may be conducted for all combinations of the structural parameter values each of which is altered stepwise at a small pitch. However, if it is found from the measurement of the characteristic values that a certain structural parameter or parameters are not critical to the characteristics of the filter, the Step S21 may be conducted so as to skip such parameter or parameters, i.e., without altering the values of such parameter or parameters.

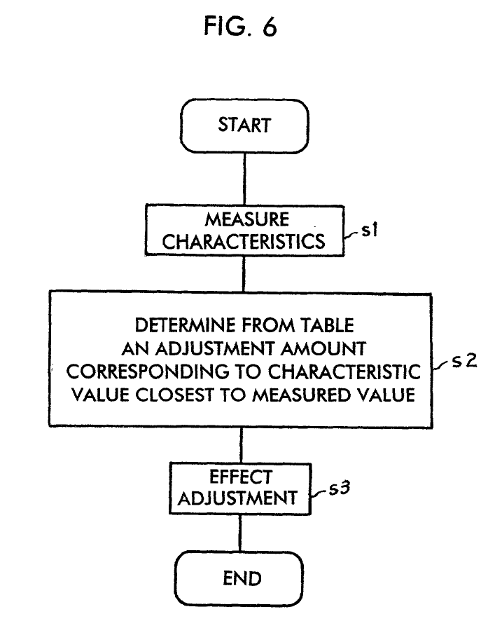

A description will now be given of a second embodiment of the method of the invention for adjusting characteristics of a dielectric filter, with specific reference to FIGS. 6 to 8.

FIG. 6 is a flowchart showing the whole process for the characteristics adjustment. The process begins with Step S1 which measures the characteristics of the dielectric filter in the same way as that performed in the first embodiment. Then, Step S2 is conducted to determine the differences between the characteristic values measured in Step S1 and the design characteristic values. Step S2 also refers to a table to determine amounts of adjustments to be effected on respective portions to be adjusted. Then, Step S3 is performed to effect the adjustments on these portions by the amounts determined in Step S2, by means of the laser trimming.

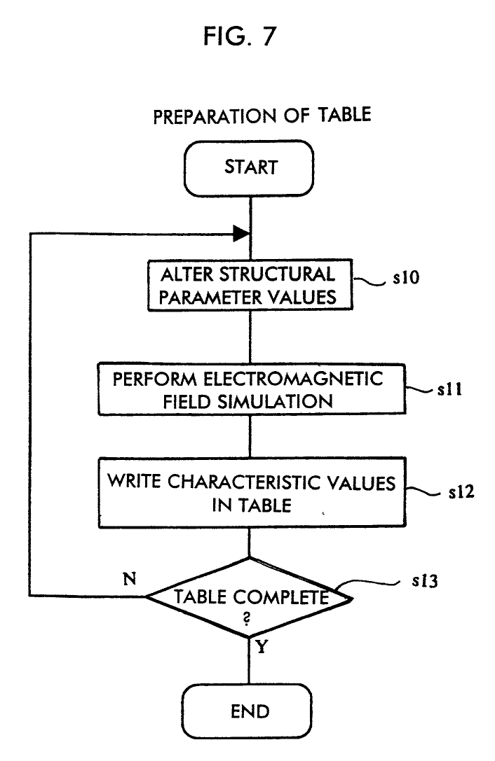

FIG. 7 is a flowchart showing the procedure for forming the table data. In Step S10, structural parameters are altered by predetermined values from the design values. In Step S11, the filter characteristics are analyzed through an electromagnetic field simulation by using the altered parameter values. In Step S12, the correlations between the structural parameter values and the filter characteristics as determined in the preceding step are written as table data. The above-described series of steps, i.e., alteration of the structural parameter values, electromagnetic field simulation, and the writing of the correlations as the table data, are cyclically repeated to obtain data for all combinations of the structural parameter values each of which is altered stepwise by a unit amount. Step S13 completes the table data which show the correlations between the amounts of adjustments and filter characteristic values obtained through the adjustments.

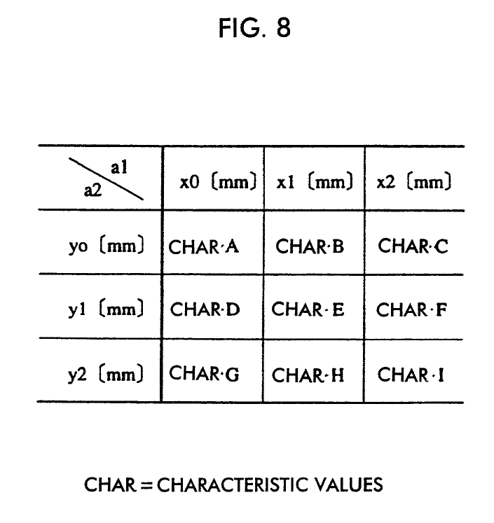

FIG. 8 shows, by way of example, table data as obtained with combinations between two portions to be adjusted, i.e., two structural parameters, which are the dimensions a1 and a2 shown in FIG. 1. More specifically, this figure shows the filter characteristics as obtained when the dimension a1 of the open-surface electrode 3a is varied over three stages x0, x1 and x2, while the dimension 1b of the open-surface electrode 3c is varied over three stages y0, y1 and y2. It is assumed here that the simulated filter exhibits characteristic values B when the dimensions a1 and a2 have been increased by the amounts x1 and y0, respectively. Assuming also that the characteristic values B most closely approximate the characteristic values as obtained through the measurement conducted in Step S1 of FIG. 6, characteristics closely approximating the design characteristic values can be obtained by trimming the open-surface electrodes 3a and 3c by the amounts x1 and y0, respectively. Thus, the table data shown in FIG. 8 are used to determine the amounts of adjustments to be effected in order that the respective characteristic values before the adjustments are corrected to the design characteristic values.

The table data shown in FIG. 8 is two-dimensional, because there are two portions, i.e., two structural parameters, to be adjusted. This, however, is not exclusive and the number of orders of the table data is variable depending on the number of the structural parameters to be adjusted.

In the embodiments described heretofore, the characteristics of a dielectric filter having a dielectric block are adjusted by trimming the electrodes provided on the open end surface of the dielectric block. This also is only illustrative and the method of the present invention may be carried out by using the input and output electrodes as the portions to be adjusted, i.e., by adjusting dimensions of the input and output electrodes in a predetermined direction.

The structural parameters to be adjusted are not limited to the dimensions of the electrodes. Namely, in accordance with the present invention, the characteristics of the dielectric filter may be adjusted by cutting a predetermined portion of the dielectric block at the open surface thereof, or by partially removing the outer conductor on the short-circuit surface by cutting.

The use of the laser trimming technique as described is also illustrative. Namely, the trimming for adjusting the characteristics may be effected mechanically by removing suitable portions of the electrode or the dielectric block by means of, for example, a grinding wheel.

As will be understood from the foregoing description, the present invention offers the following advantages.

According to the present invention, it is possible to appropriately determine the amounts of adjustments which are necessary for correcting the characteristic values measured on an actual product to the final or design characteristics of the product. It is therefore possible to easily obtain the products having the desired characteristics without fail.

In addition, since the correlations between the amounts of variations of structural parameters and the deviations of the characteristic values from design values are obtained beforehand, it is possible to quickly determine the amounts of adjustments to be effected, thus shortening the time required for the adjustment of the characteristics.

In accordance with the present invention, the adjustment or alteration of each structural parameter value is effected stepwise. The amount of alteration of the parameter value to be effected in each step is set to be smaller than the amount of adjustment that is necessary for achieving the desired characteristic value. Thus, the series of the adjusting process steps, such as the measurement of the characteristics, determination of the amount of adjustment to be effected on each structural parameter, and the actual adjustment, are cyclically repeated with small amount of adjustment in each cycle. This allows the actual characteristic values to progressively approach the design characteristic values, while avoiding any mis-adjustment which otherwise may occur due to overshoot or excessive adjustment.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of adjusting characteristics of an electronic part, comprising:
(a) measuring at least one characteristic of said electronic part;
(b) performing an electromagnetic field simulation to determine the value of said characteristic which is to be obtained when the value of at least one structural parameter of said electronic part is varied from a design value; and
(c) adjusting said structural parameter based on step (b).

2. A method of adjusting characteristics of an electronic part, comprising:
(a) measuring at least one characteristic of said electronic part;
(b) performing an electromagnetic field simulation to determine a value of said characteristic which is to be obtained when the value of at least one of a plurality of structural parameter of said electronic part is varied from a design value, said plurality of structural parameters being dimensions of a plurality of pre-selected portions of said electronic part;
(c) determining the amount of variation of the value of the structural parameter from the design value which has to be effected to make the measured value of said characteristic fall within a predetermined range of allowable error from the design value; and
(d) adjusting the value of said structural parameter by an amount corresponding to said amount of variation.

3. A method of adjusting characteristics of an electronic part according to claim 2, further comprising the steps of:
determining, from the results of said electromagnetic field simulation, correlations between the amounts of variations of the value of the structural parameter and the amounts of deviations of the value of said characteristic from the design value; and
storing the correlations in the form of table data;
wherein the amount of variation of the value of the structural parameter, determined in step (c) and corresponding to the amount of deviation of the measured value of said item of the characteristics from the design characteristic value, is derived from said table data.

4. A method of adjusting characteristics of an electronic part according to claim 3, wherein steps (a)-(d) are cyclically repeated while setting the amount of adjustment in step (d) in each cycle to a value smaller than said amount of variation, thereby bringing the value of said characteristic closer to the design value.
